(19) United States
(12) Patent Application Publication
(10) Pub. No.: US 2017/0343986 A1
(43) Pub. Date: Nov. 30, 2017

(54) METHODS AND SYSTEM FOR ENHANCING FLOW OF A GAS LIFTED WELL

(71) Applicant: General Electric Company, Schenectady, NY (US)

(72) Inventors: Jinfeng Zhang, Edmond, OK (US); Deepak Aravind, Bangalore (IN); Victor Jose Acacio, Cypress, TX (US); Jared Markes, Edmond, OK (US); Jewell Cope, Oklahoma City, OK (US); Sam Marsh Stroder, Edmond, OK (US); James Holland, Houston, TX (US); John Esterheld, Oklahoma City, OK (US)

(21) Appl. No.: 15/169,141

(22) Filed: May 31, 2016

(51) Int. Cl. G05B 19/416; E21B 41/00; E21B 43/12; E21B 47/06; E21B 34/06

(52) U.S. Cl. CPC G05B 19/416; E21B 47/06; E21B 47/065; E21B 34/06; E21B 43/122; E21B 41/0092; G05B 2219/37371

(57) ABSTRACT

A system for enhancing a flow of a fluid induced by a gas lift system includes one or more sensors and a gas lift control unit configured to control the flow of the fluid induced by the gas lift system. The gas lift control unit is configured to: (a) receiving signals representing measured data from the one or more sensors, (b) calculating a desired gas injection rate and its associated flow of fluid based, at least in part, on the measured data, (c) regulating at least one operating characteristic of a compressor associated with the gas lift system based, at least in part, on the desired gas injection rate, (d) receiving measured data representing production data, and (e) determining a subsequent adjustment based on a comparison of the desired flow of fluid and the production data.

### BACKGROUND

The field of the invention relates generally to controlling gas lift wells, and more specifically, to methods and a system for controlling a gas lift well to enhance the flow of fluid and gas induced by gas lift.

Gas lift uses the injection of gas into a production well to increase the flow of liquids, such as crude oil or water, from the production well. Gas is injected down the casing and ultimately into the tubing of the well at one or more downhole locations to reduce the weight of the hydrostatic column. This effectively reduces the density of the fluid in the well and further reduces the back pressure, allowing the reservoir pressure to lift the fluid out of the well. As the gas rises, the bubbles help to push the fluid ahead. The produced fluid can be oil, water, or a mix of oil and water, typically mixed with some amount of gas.

The gas lift operations are exposed to a wide range of conditions. These vary by well location, reservoir types, etc. Furthermore, well conditions, such as downhole pressure, may change over time. Therefore ideal operating condition of the well may change over time. These conditions may cause variability in the flow of the fluid. These changes in conditions may reduce the efficiency and production of the gas lift well. Further, some gas lift wells may be in remote areas requiring significant effort for personnel to travel to.

### BRIEF DESCRIPTION

In one aspect, a system for enhancing a flow of a fluid induced by a gas lift system is provided. The system includes one or more sensors configured to monitor one or more conditions of the gas lift system and generate signals representing measured data based on the one or more conditions. The system also includes a gas lift control unit comprising a processor and a memory coupled to the processor. The gas lift control unit in communication with that one or more sensors and is configured to control a flow of gas injected in a well by the gas lift system, thereby controlling the flow of the fluid induced by the gas lift system. The gas lift control unit is configured to (a) receiving signals representing measured data from the one or more sensors. The gas lift control unit is also configured to (b) calculating a desired gas injection rate and its associated flow of fluid based, at least in part, on the measured data. The gas lift control unit is further configured to (c) regulating at least one operating characteristic of a compressor associated with the gas lift system based, at least in part, on the desired gas injection rate. Moreover, the gas lift control unit is configured to (d) receiving measured data representing production data. In addition the gas lift control unit is configured to (e) determining a subsequent adjustment based on a comparison of the desired flow of fluid and the production data.

In a further aspect, a computer-based method for enhancing a flow of a fluid induced by a gas lift system is provided. The method is implemented using a gas lift control unit including at least one processor in communication with a memory. The method includes (a) receiving signals representing measured data from one or more sensors. The one or more sensors are configured to monitor one or more conditions of the gas lift system and generate signals representing measured data based on the one or more conditions. The method also includes (b) calculating a desired gas injection rate and its associated flow of fluid based, at least in part, on the measured data. The method further includes (c) regulating at least one operating characteristic of a compressor associated with the gas lift system based, at least in part, on the desired gas injection rate. Moreover, the method includes (d) receiving measured data representing production data. In addition, the method includes (e) determining a subsequent adjustment based on a comparison of the desired flow of fluid and the production data.

In another aspect, a computer-readable storage device having processor-executable instructions embodied thereon for enhancing a flow of a fluid induced by a gas lift system is provided. When executed by a gas lift control unit communicatively coupled to a memory, the processor-executable instructions cause the gas lift control unit to (a) receive signals representing measured data from one or more sensors. The one or more sensors are configured to monitor one or more conditions of the gas lift system and generate signals representing measured data based on the one or more conditions. The processor-executable instructions also cause the gas lift control unit to (b) calculate a desired gas injection rate and its associated flow of fluid based, at least in part, on the measured data. The processor-executable instructions further cause the gas lift control unit to (c) regulate at least one operating characteristic of a compressor associated with the gas lift system based, at least in part, on the desired gas injection rate. Moreover, the processor-executable instructions cause the gas lift control unit to (d) receive measured data representing production data. In addition, the processor-executable instructions cause the gas lift control unit to (e) determine a subsequent adjustment based on a comparison of the desired flow of fluid and the production data.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary gas lift system;

FIG. 2 is a schematic view of a system for controlling the gas lift system shown in FIG. 1;

FIG. 3 is a schematic view of an exemplary configuration of a client device that may be used with the system shown in FIG. 2;

FIG. 4 is a schematic view of an exemplary configuration of a gas lift control unit that may be used with the system shown in FIG. 2; and

FIG. 5 is a flow chart of an extraction process for the gas lift system shown in FIG. 1 using the system shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that may permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), a programmable logic unit (PLU), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The method and systems described herein provide for managing and enhancing the operation of a gas lift system at a well. Furthermore, the method and systems described herein facilitate more efficient operation of a gas lift system to rapidly respond to changes in conditions of the well. These methods and systems facilitate regulating multiple characteristics of a gas lift system to enhance the amount of time that the gas lift system is operating at peak efficiency based on current and potentially changing well conditions. Also, the system and methods described herein are not limited to any single type of gas lift system or type of well, but may be implemented with any gas lift system that is configured as described herein. For example, the method and systems described herein may be used with any other device capable of producing fluids using a gas lift system. By constantly monitoring conditions in real-time and regulating the operation of the gas lift system based on the conditions, the system and method described herein facilitates more efficient operation of gas lift systems while facilitating consistent and enhanced production.

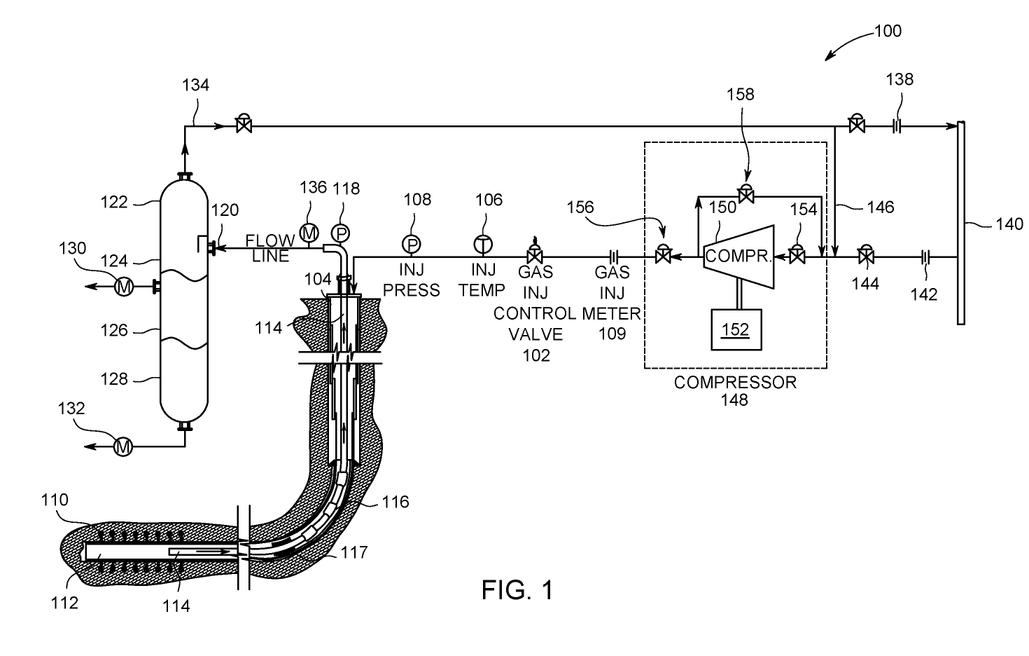

FIG. 1 is a schematic view of an exemplary gas lift system 100. Gas lift system 100 includes a gas injection control valve 102 which regulates a quantity of gas injected into a well 104. In the exemplary embodiment, well 104 is a hole drilled for extracting fluid, such as crude oil, water, or gas, from the ground. The gas is injected into well 104 and proceeds downhole. While the gas is being injected, an injection temperature sensor 106, an injection pressure sensor 108, and a gas injection meter 109 take measurements at the surface. The injected gas induces a reduction in the density of one or more fluids 110 in well 104, so that the reservoir pressure 112 can be sufficient to push fluids 110 up a tubing 114. In the exemplary embodiment, fluids 110 are a mix of oil, water, and gas. One or more gas lift valves 116 assist the flow of fluids 110 up tubing 114. In some embodiments, downhole temperature and pressure sensors 117 take measurements at downhole locations.

At the top of well 104, flow tube pressure sensor 118 measures the wellhead tubing pressure. A flow line 120 channels fluids 110 to a separator 122. Separator 122 separates fluid 110 into gas 124, oil, 126, and water 128. Oil 126 is removed by separator 122 and the amount of oil retrieved is metered by oil meter 130. Water 128 is also removed by separator 122 and the amount of water retrieved is metered by water meter 132. Gas 124 is siphoned out of separator 122 through gas line 134. In some embodiments, multi-phase flow meter 136 replaces oil meter 130 and water meter 132. In these embodiments, multi-phase flow meter 136 is used to measure production. Some gas 124 is transferred to a gas pipeline 140 through a gas production meter 138. In the exemplary embodiment, some gas 124 is transferred to a compressor 148 though a flow line 146.

In some embodiments, such as when there is not enough gas pressure to inject into well 104, gas 124 may be obtained and purchased from gas pipeline 140 through a buy back valve 144 and measured by a buy back meter 142. This may occur also when initially placing well 104 into service or restarting well 104 after down time.

Gas 124 enters compressor 148 through compressor suction valve 154. In the example embodiment, compressor 148 includes compressor motor 150. Compressor 148 compresses gas 124. Compressor controller 152 regulates the speed of compressor motor 150. In some embodiments, the speed of compressor motor 150 is measured in regulating the revolutions per minute (RPM) of compressor motor 150. Compressor back pressure valve 156 ensures sufficient discharge pressure for the well and recycles excessive gas back to the compressor suction valve 154. Compressor recycle valve 158 is an overflow valve that reintroduces gas 124 above a certain pressure back into compressor 148 through compressor suction valve 154. Gas 124 flows from compressor 148 to well 104. The amount of gas that is injected into well 104 is measured by gas injection meter 109.

During normal operation of gas lift system 100, gas 124 is compressed by compressor 148. The amount of gas 124 injected into well 104 is controlled by gas injection control valve 102 and measured by gas injection meter 109. In well 104, gas 124 mixes with fluids 110. The mixture of fluids 110 and gas 124 is pushed up through tubing 114 to the top of well 104 by reservoir pressure 112. The mixture of gas 124 and fluids 110 travels through flow line 120 into separator 122, where fluids 110 and gas 124 are separated. A quantity of gas 124 is routed back to compressor 148 to be reinjected into well 104. Excess gas 124 is routed to gas pipeline 140 to be sold or otherwise used elsewhere. In some embodiments, some gas 124 is used to power compressor motor 150.

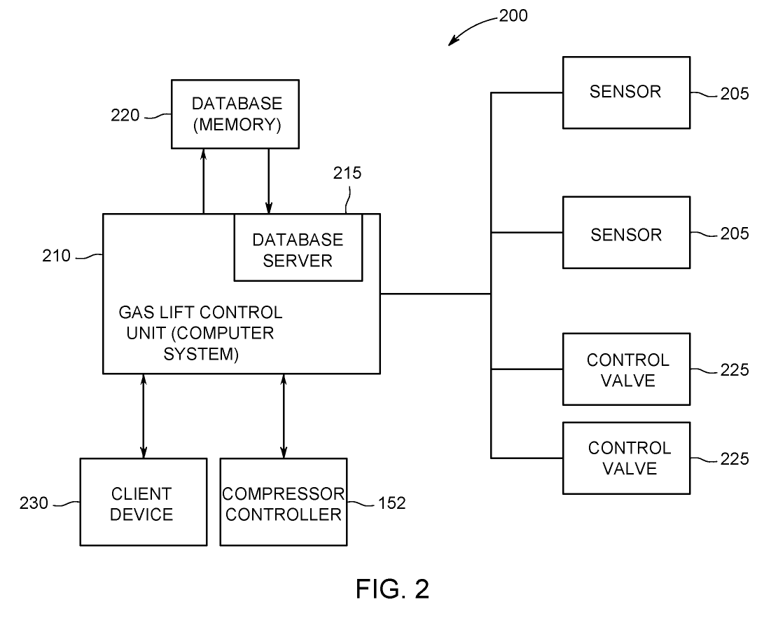

FIG. 2 is a schematic view of a system 200 for controlling gas lift system 100 (shown in FIG. 1). In the exemplary embodiment, system 200 is used for compiling and responding to data from a plurality of sensors 205 and regulating the injection of gas 124 into well 104 (both shown in FIG. 1) by gas lift system 100. As described below in more detail, gas lift control unit 210 may be configured to (a) receive signals representing measured data from the one or more sensors 205, (b) calculate a desired gas injection rate and its associated flow of fluid 110 (shown in FIG. 1) based, at least in part, on the measured data, (c) regulate at least one operating characteristic of compressor 148 (shown in FIG. 1) associated with gas lift system 100 based on the based, at least in part, on the desired gas injection rate, (d) receive measured data representing production data, and (e) determine a subsequent adjustment based on a comparison of the desired flow of fluid and the production data, and return to step (a).

Sensors 205 are in communication with a gas lift control unit 210. Sensors 205 couple to gas lift control unit 210 through interfaces including, without limitation, a network, such as a local area network (LAN) or a wide area network (WAN), dial-in-connections, cable modems, Internet connection, wireless, and special high-speed Integrated Services Digital Network (ISDN) lines. Sensors 205 receive data about gas lift system 100 operating conditions and report those conditions to gas lift control unit 210. Sensors 205 may include, but are not limited to, injection temperature sensor 106, injection pressure sensor 108, gas injection meter 109, downhole sensors 117, flow tube pressure sensor 118, oil meter 130, water meter 132, multi-phase flow meter 136, gas production meter 138, and buy back meter 142 (all shown in FIG. 1). System 200 may include more or less sensors 205 as needed to enable system 200 to function as described herein.

Gas lift control unit 210 is in communication with compressor controller 152 (shown in FIG. 1). In the exemplary embodiment, compressor controller 152 is in communication with compressor motor 150 (shown in FIG. 1). Compressor controller 152 transmits data to gas lift control unit 210 and receives commands from gas lift control unit 210. In the exemplary embodiment, compressor controller 152 regulates the speed and/or the RPM of compressor motor 150. Compressor controller 152 couples to gas lift control unit 210 through interfaces including, without limitation, a network, such as a local area network (LAN) or a wide area network (WAN), dial-in-connections, cable modems, Internet connection, wireless, and special high-speed Integrated Services Digital Network (ISDN) lines.

Gas lift control unit 210 is in communication with a plurality of control valves 225. Control valves 225 regulate the various valves in gas lift system 100. In the exemplary embodiment, a control valve 225 regulates the gas injection rate through gas injection rate control valve 102 (shown in FIG. 1). In other embodiments, valve controllers 225 also regulate compressor suction valve 154 and compressor recycle valve 158 (both shown in FIG. 1). Gas lift control unit 210 may regulate any valve that enables system 200 to operate as described herein. Control valves 225 couple to gas lift control unit 210 through interfaces including, without limitation, a network, such as a local area network (LAN) or a wide area network (WAN), dial-in-connections, cable modems, Internet connection, wireless, and special high-speed Integrated Services Digital Network (ISDN) lines.

A database server 215 is coupled to database 220, which contains information on a variety of matters, as described below in greater detail. In one embodiment, centralized database 220 is stored on gas lift control unit 210. In an alternative embodiment, database 220 is stored remotely from gas lift control unit 210 and may be non-centralized. In some embodiments, database 220 includes a single database having separated sections or partitions or in other embodiments, database 220 includes multiple databases, each being separate from each other. Database 220 stores condition data received from multiple sensors 205. In addition, and without limitation, database 220 stores constraints, component data, component specifications, equations, and historical data generated as part of collecting condition data from multiple sensors 205.

In some embodiments, gas lift control unit 210 is in communication with a client device 230, also known as a client system 230. Gas lift control unit 210 couples to client device 230 through many interfaces including, without limitation, a network, such as a local area network (LAN) or a wide area network (WAN), dial-in-connections, cable modems, Internet connection, wireless, and special high-speed Integrated Services Digital Network (ISDN) lines. In these embodiments, gas lift control unit 210 transmits data about the operation of gas lift system 100 to client device 230. This data includes, without limitation, data from sensors 205, current RPM, the status of various valves, and other operational data that client device 230 is configured to monitor. Furthermore, gas lift control unit 210 is configured to receive additional instructions from client device 230. Additionally, client device 230 is configured to access database 220 through gas lift control unit 210. Client device 230 is configured to present the data from gas lift control unit 210 to a user. In other embodiments, gas lift control unit 210 includes a display unit (not shown) to display data directly to a user.

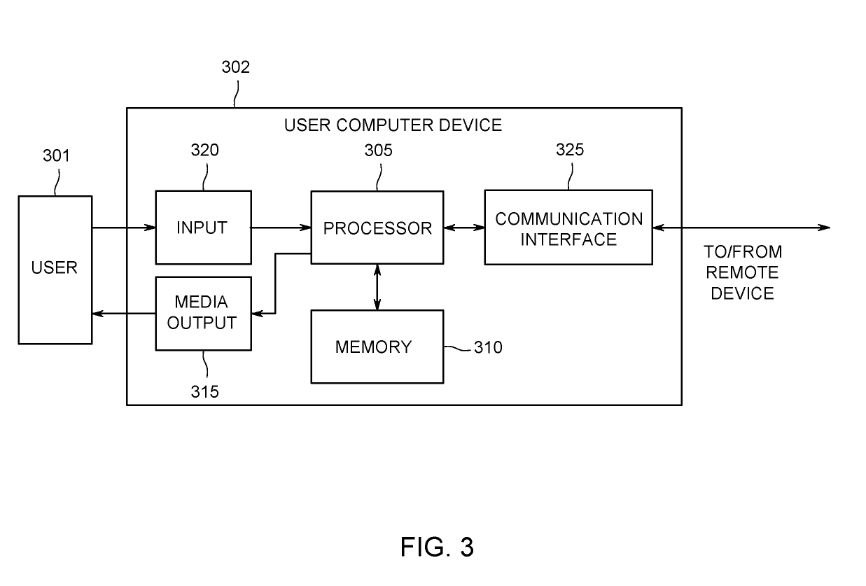

FIG. 3 illustrates an exemplary configuration of client system 230 shown in FIG. 2. A user computer device 302 is operated by a user 301. User computer device 302 may include, but is not limited to, client systems 230, compressor controller 152, and control valves 225 (all shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 includes one or more computer-readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, a dashboard for monitoring sensor measurements, a control screen for controlling operation of user computer device 302, and/or an update screen for updating software in user computer device 302. In some embodiments, user computer device 302 includes an input device 320 for receiving input from user 301. User 301 may use input device 320 to, without limitation, select and/or enter one or more sensor measurements to view. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as gas lift control unit 210 (shown in FIG. 2). Communication interface 325 may include, for example, a wired or wireless network adapter and/or a wireless data transceiver for use with a mobile telecommunications network.

Stored in memory area 310 are, for example, computer-readable instructions for providing a user interface to user 301 via media output component 315 and, optionally, receiving and processing input from input device 320. The user interface may include, among other possibilities, a web browser and/or a client application. Web browsers enable users, such as user 301, to display and interact with media and other information typically embedded on a web page or a website from gas lift control unit 210. A client application allows user 301 to interact with, for example, gas lift control unit 210. For example, instructions may be stored by a cloud service and the output of the execution of the instructions sent to the media output component 315.

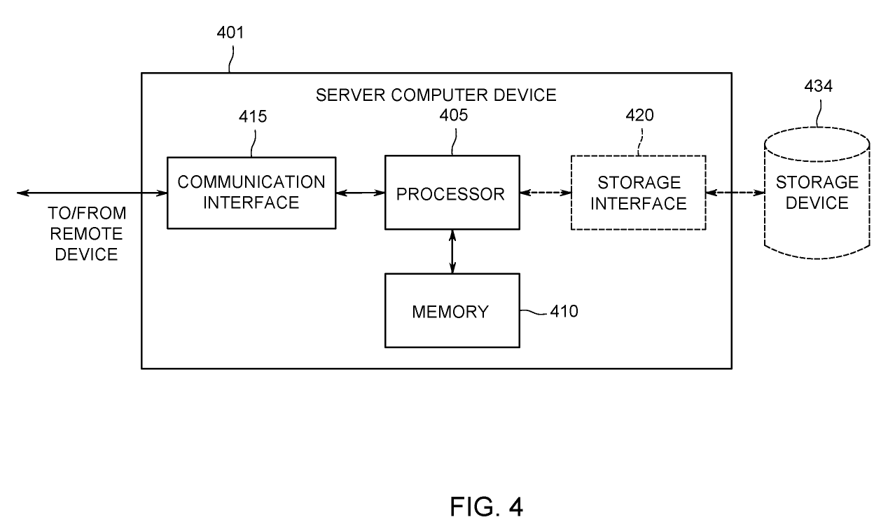

FIG. 4 illustrates an example configuration of gas lift control unit 210 shown in FIG. 2, in accordance with one embodiment of the present disclosure. Server computer device 401 may include, but is not limited to, database server 215 and gas lift control unit 210 (both shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 230, sensors 205, control valves 225, compressor controller 152, or gas lift control unit 210 (all shown in FIG. 2). For example, communication interface 415 may receive requests from client systems 230 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

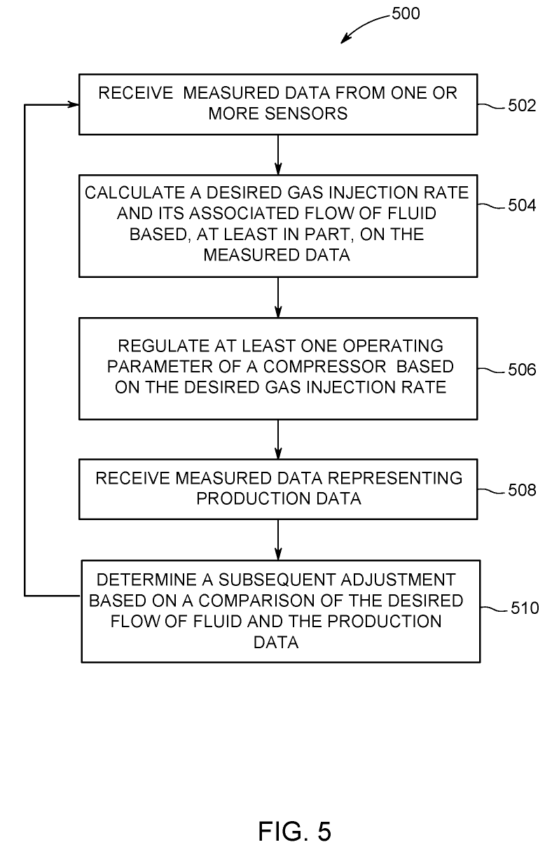

Processor 405 executes computer-executable instructions for implementing aspects of the disclosure. In some embodiments, processor 405 is transformed into a special purpose microprocessor by executing computer-executable instructions or by otherwise being programmed. For example, processor 405 is programmed with the instructions such as are illustrated in FIG. 5.

FIG. 5 is a flow chart of an extraction process 500 for gas lift system 100 shown in FIG. 1 using system 200 shown in FIG. 2. In the exemplary embodiment, process 500 is performed by gas lift control unit 210 (shown in FIG. 2). Process 500 is a real-time process and further is an iterative and continually looping process. As the steps of process 500 are completed, the efficiency of production for gas lift system 100 potentially changes as gas lift system 100 asymptotically approaches the ideal or desired conditions for the current well. In some embodiments, the steps of process 500 are performed in rapid succession. In other embodiments, the steps of process 500 are performed every five minutes. In another embodiment, the steps of process 500 are performed every hour. Alternatively, the steps of process 500 are performed at any intervals that enable operation of gas lift system 100 and system 200 as described herein.

In the exemplary embodiment, gas lift control unit 210 receives 502 signals representing measured data from one or more sensors 205 (shown in FIG. 2). As described above, sensors 205 provide information about current conditions of gas lift system 100 and well 104 (shown in FIG. 1). In some embodiments, measured data includes the temperature and pressure at the top of well 104 and downhole in well 104. Other examples of measured data includes an amount of fluid 110 (shown in FIG. 1) exiting well and the amount of gas 124 (shown in FIG. 1) that has been injected into well 104. In some embodiments, measured data may be based on real-time measurements. In other embodiments, gas lift control unit 210 may receive 502 measured data for a period of time and store the received measured data in database 220 (shown in FIG. 2).

Gas lift control unit 210 calculates 504 a desired gas injection rate and its associated flow of fluid 110 based, at least in part, on the measured data. In the exemplary embodiment, measured data is based on current conditions in well 104. These conditions may change over time, and accordingly the desired flow of fluid 110 may also change overtime. Step 504 facilitates gas lift control unit 210 constantly updating the enhanced flow rate based on current well conditions. In some embodiments, gas lift control unit 210 analyzes measured data over a period of time to calculate 504 the desired gas injection rate and desired flow of fluid 110.

Gas lift control unit 210 regulates 506 (also known as adjusting or changing) at least one operating characteristic of compressor 148 (shown in FIG. 1) based on the desired gas injection rate. In the exemplary embodiment, gas lift control unit 210 regulates 506 the RPM of compressor motor 150 (shown in FIG. 1). In other embodiments, gas lift control unit 210 regulates the settings of compressor suction valve 154 or compressor recycle valve 158 (both shown in FIG. 1). These adjustments regulate the amount of gas 124 that is being injected into well 104 and thereby regulate the amount of fluids 110 that is extracted from well 104. In some embodiments, gas lift control unit 210 also regulates gas injection control valve 102 (shown in FIG. 1).

Gas lift control unit 210 receives 508 additional measured data including production data. For example, gas lift control unit 210 receives 508 the production data from flow tube pressure sensor 118, oil meter 130, water meter 132, multi-phase flow meter 136, and/or gas production meter 138. In some embodiments, gas lift control unit 210 analyzes measured data over a period of time to compare 506 to the desired flow of fluid 110. In some embodiments, gas lift control unit 210 instructs that an amount of gas 124 to be injected into well 104 while receiving production data. The amount of gas 124 may vary depending on the current implementation and settings. In some embodiments, gas lift control unit 210 generates a comparison between the production data and the desired flow of fluid 110. Gas lift control unit 210 determines 510 a subsequent adjustment to gas lift system 100 based on the comparison between the desired flow of fluid 110 and the received production data 510. For example, gas lift control unit 210 may determine 510 to increase the RPM of compressor 148. In another example, gas lift control unit 210 may determine 510 that the production indicates that gas lift system 100 is producing at the desired flow of fluid 110 and determine to not take further actions.

In the exemplary embodiment, the above described process 500 is an iterative process and will repeat as conditions in well 104 and the comparison of desired flow of fluid 110 to measured data changes. In some embodiments, desired operating characteristics, methodologies, or other business rules will modify the regulation 506 of compressor 148 and valves. These regulations 506 may be either increases or decreases and may change in magnitude. While system 200 may reach a steady state, process 500 is potentially continuously regulating the settings of gas lift system 100.

The above-described method and system provide for managing and enhancing the operation of a gas lift system at a well. Furthermore, the method and systems described herein facilitate more efficient operation of a gas lift system to rapidly respond to changes in conditions of the well. These methods and systems facilitate regulating multiple characteristics of a gas lift system to enhance the amount of time that the gas lift system is operating at peak efficiency based on current and potentially changing well conditions. Also, the system and methods described herein are not limited to any single type of gas lift system or type of well, but may be implemented with any gas lift system that is configured as described herein. For example, the method and systems described herein may be used with any other device capable of extracting fluids using a gas lift system. By constantly monitoring conditions in real-time and regulating the operation of the gas lift system based on the conditions, the system and method described herein facilitates more efficient operation of gas lift systems while facilitating consistent and enhanced production.

An exemplary technical effect of the methods, systems, and apparatus described herein includes at least one of: (a) rapidly responding to changes in conditions in a well; (b) facilitating consistent flow of oil from a well; (c) automatically enhancing output of a well; and (d) independently operating each well.

Exemplary embodiments of method and systems for controlling a gas lift system are described above in detail. The method and systems described herein are not limited to the specific embodiments described herein, but rather, components of systems or steps of the methods may be utilized independently and separately from other components or steps described herein. For example, the methods may also be used in combination with multiple different gas lift system, and are not limited to practice with only the gas lift systems as described herein. Additionally, the methods may also be used with other fluid sources, and are not limited to practice with only the fluid sources as described herein. Rather, the exemplary embodiments may be implemented and utilized in connection with many other gas lift devices to be operated as described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for enhancing a flow of a fluid induced by a gas lift system, said system comprising:
one or more sensors configured to monitor one or more conditions of the gas lift system and generate signals representing measured data based on the one or more conditions; and
a gas lift control unit comprising a processor and a memory coupled to said processor, said gas lift control unit in communication with said one or more sensors, said gas lift control unit configured to control the flow of the fluid induced by the gas lift system by:
(a) receiving signals representing measured data from the one or more sensors;
(b) calculating a desired gas injection rate and its associated flow of fluid based, at least in part, on the measured data;
(c) regulating at least one operating characteristic of a compressor associated with the gas lift system based, at least in part, on the desired gas injection rate;
(d) receiving measured data representing production data; and
(e) determining a subsequent adjustment based on a comparison of the desired flow of fluid and the production data.

2. The system in accordance with claim 1, wherein said gas lift control unit is further configured to regulate a gas injection control valve based on the comparison.

3. The system in accordance with claim 1, wherein said gas lift control unit is further configured to regulate a compressor suction control valve associated with the compressor based on the comparison.

4. The system in accordance with claim 1, wherein said gas lift control unit is further configured to regulate a compressor recycle control valve associated with the compressor based on the comparison.

5. The system in accordance with claim 1, wherein the at least one operating characteristic of the compressor includes a speed of the compressor.

6. The system in accordance with claim 1, wherein the one or more sensors include at least one of a flow tubing pressure sensor, an oil production meter, a water production meter, a gas production meter, a multi-phase production meter, a buy back meter, a gas injection meter, an injection pressure meter, and an injection temperature sensor.

7. The system in accordance with claim 1, wherein the one or more sensors include at least one of a down hole pressure meter and a down hole temperature sensor.

8. A computer-based method for controlling a flow of a fluid induced by a gas lift system, said method implemented using a gas lift control unit including at least one processor in communication with a memory, said method comprising:
(a) receiving signals representing measured data from one or more sensors, wherein the one or more sensors are configured to monitor one or more conditions of the gas lift system and generate signals representing measured data based on the one or more conditions;
(b) calculating a desired flow of fluid based, at least in part, on the measured data;
(c) regulating at least one operating characteristic of a compressor associated with the gas lift system based, at least in part, on the desired gas injection rate;
(d) receive measured data representing production data; and
(e) determining a subsequent adjustment based on a comparison of the desired flow of fluid and the production data.

9. The method in accordance with claim 8 further comprising regulating a gas injection control valve based on the comparison.

10. The method in accordance with claim 8 further comprising regulating a compressor suction control valve associated with the compressor based on the comparison.

11. The method in accordance with claim 8 further comprising regulating a compressor recycle control valve associated with the compressor based on the comparison.

12. The method in accordance with claim 8, wherein the at least one operating characteristic of the compressor includes a speed of the compressor.

13. The method in accordance with claim 8, wherein receiving signals representing measured data further comprises receiving signals from one or more of a flow tubing pressure sensor, an oil production meter, a water production meter, a gas production meter, a multi-phase production meter, a buy back meter, a gas injection meter, an injection pressure meter, and an injection temperature sensor.

14. The method in accordance with claim 8, wherein receiving signals representing measured data further comprises receiving signals from one or more of a down hole pressure meter and a down hole temperature sensor.

15. A computer-readable storage device having processor-executable instructions embodied thereon, for enhancing a flow of a fluid induced by a gas lift system, wherein when executed by a gas lift control unit communicatively coupled to a memory, the processor-executable instructions cause the gas lift control unit to:
(a) receive signals representing measured data from one or more sensors, wherein the one or more sensors are configured to monitor one or more conditions of the gas lift system and generate signals representing measured data based on the one or more conditions;
(b) calculate a desired gas injection rate and its associated flow of fluid based, at least in part, on the measured data;
(c) regulate at least one operating characteristic of a compressor associated with the gas lift system based, at least in part, on the desired gas injection rate;
(d) receive measured data representing production data; and
(e) determine a subsequent adjustment based on a comparison of the desired flow of fluid and the production data.

16. The computer readable storage device of claim 15, wherein the processor-executable instructions cause the gas lift control unit to regulate a gas injection control valve based on the comparison and regulate gas injection into the well.

17. The computer readable storage device of claim 15, wherein the processor-executable instructions cause the gas lift control unit to regulate a compressor suction control valve associated with the compressor based on the comparison.

18. The computer readable storage device of claim 15, wherein the processor-executable instructions cause the gas lift control unit to regulate a compressor recycle control valve associated with the compressor based on the comparison.

19. The computer readable storage device of claim 15 wherein the at least one operating characteristic of the compressor includes a speed of the compressor.

20. The computer readable storage device of claim 15 wherein the one or more sensors include at least one of a flow tubing pressure sensor, an oil production meter, a water production meter, a gas production meter, a multi-phase production meter, a buy back meter, a gas injection meter, an injection pressure meter, an injection temperature sensor, a down hole pressure meter, and a down hole temperature sensor.
